(19) United States
(12) Patent Application Publication
(10) Pub. No.: US 2015/0089781 A1
(43) Pub. Date: Apr. 2, 2015

(54) Ball and Socket Joint Retention for a Hydraulic Pump/Motor

(71) Applicants: Daniel W. Barba, New Hudson, MI (US); Charles L. Gray, JR., Pinckney, MI (US); Mark Doorlag, Ypsilanti, MI (US)

(72) Inventors: Daniel W. Barba, New Hudson, MI (US); Charles L. Gray, JR., Pinckney, MI (US); Mark Doorlag, Ypsilanti, MI (US)

(21) Appl. No.: 14/039,330

(22) Filed: Sep. 27, 2013

(51) Int. Cl. F16C 11/06; B21D 39/00

(52) U.S. Cl. CPC F16C 11/0685; B21D 39/00; F16C 11/06
USPC 29/90.01; 29/516; 72/462; 403/122

(57) ABSTRACT

Embodiments for retaining the spherical ball of a piston connecting rod within a socket in a bore in a drive plate of a bent-axis pump/motor comprise swaging material at the periphery of the socket cavity toward the ball, to an outer diameter such that the swaged region is fully supported against pullout by the cylindrical wall of the bore. Alternatively, a retention ring which is fully supported by the walls of the cylindrical bore retains the ball within the socket and is in turn retained by a snap ring extending into a groove within the bore.

### CROSS-REFERENCE TO RELATED APPLICATIONS

This application claims priority from U.S. Provisional Application 61/707,181, “Ball and Socket Joint Retention for a Bent-Axis Pump/Motor,” filed Sep. 28, 2012.

### BACKGROUND OF THE INVENTION

1. Technical Field

The disclosed embodiments are directed generally to the task of assembling a ball and socket joint to be installed into a bore of a hydraulic pump/motor.

2. Description of the Related Art

Hydraulic pump/motors, particularly bent-axis axial piston hydraulic pump/motors, are employed in hydraulic hybrid vehicles as well as other hydraulic devices. Such a pump/motor has a plurality of working pistons, each having a connecting rod with a spherical ball end that resides and articulates within a respective socket cavity residing on a drive plate. During normal operation, the force of fluid on any working piston tends to push the connecting rod toward its respective socket thus tending to keep its ball seated within the socket. However, in some cases, such as when displacement is rapidly changed (in particular, in pump mode), pull-out forces occur that tend to pull the connecting rod away from the socket.

In particular, for flooded-case pumps which have case pressure exposed to the end of the piston facing the drive plate (i.e. the bottom face) and the same pressure supplied to the porting of fluid to the end of the piston opposite the drive plate (top face), the pressure on the top face of the piston is often lower than the pressure on the bottom face of the piston, primarily because of the pressure drop in the fluid flowing through the porting of the fluid to the top face of the piston as the piston travels to intake the fluid on its downward stroke. The pressure difference can be large (e.g. 100 psi or more) at high pump speeds and displacements, leading to a large tension force on the socket and a greater strength requirement for the socket retaining means to overcome the pull-out forces. One option for reducing this tension is to maintain the case pressure at a lower pressure than what might normally be preferred for the low-pressure side of the system (e.g., a three-pressure system in which case pressure is the lower pressure). However, a three-pressure system adds to cost and complexity.

Therefore, in manufacturing such a pump/motor, it is important to provide for a retention means to effectively retain or “hold down” the connecting rod ball ends within the sockets while still allowing free articulation.

It is known to use a hold-down plate which attaches to the drive plate, holding down each ball by means of a respective hole in the plate, having a slightly smaller diameter than the diameter of the ball. This design tends to be costly to produce, assemble, and service.

It is also known to swage material around the periphery (or “lip”) of the socket cavity inwardly into a position that partially wraps around the ball and thereby helps to retain it within the socket. Each socket is provided as a short cylindrical socket body having a generally semi-spherical socket cavity in one end, tapering to a cylindrical wall somewhat above the spherical portion. The ball of a connecting rod is positioned within the cavity, and the outer cylindrical edge (lip) of the socket cavity is then swaged inwardly onto the ball. The assembled socket body is then (or simultaneously) installed into a bore on the drive plate. For the swaging operation a swaging tool may be provided with a swage cavity that approximates the final shape of the retaining edges of the socket after being deformed to hold the ball.

Applicant has found that this use of a conventionally swaged lip for the retention means commonly results in unsatisfactory strength and durability against pull-out forces, due to several factors. First, fatigue and residual stress introduced to the lip material during the swaging operation tends to reduce the strength of the material that wraps around the ball. Second, the process of installing (usually by pressing) the assembled ball and socket into an interference fit with the corresponding bore on the drive plate may introduce additional distortion that disturbs the fit of the ball in the socket. Third, and most importantly, even if a good fit is retained alter the installing operation, the socket does not retain the ball as strongly as it might because the swaging of the lip of the socket body inwardly toward the ball leaves an annular gap between the swaged lip and the side walls at the top of the cylindrical bore into which the socket body is installed. The lack of supporting material in this gap allows the inwardly-swaged lip material to deform outwardly into the gap if the ball is pulled out with sufficient force, ultimately releasing the ball from the socket and causing the joint to fail.

To these ends this application discloses various solutions to provide strength against pullout of the ball from the socket while avoiding binding of the ball by the socket upon installing the socket into the bore.

### OBJECT OF THE INVENTION

It is therefore an object of the invention to provide a means of strongly and durably assembling a connecting rod ball into a socket cavity, while providing for free articulation within the socket and sufficient strength against pull-out after the assembly is installed into a bore, in a manner that is robust and inexpensive to manufacture.

It is another object of the invention to provide for the installed socket, particularly the portion that is swaged to retain the ball, to be fully supported by the walls of the socket bore in order to provide additional strength against pull-out.

### SUMMARY OF THE INVENTION

Retention means are provided for keeping the connecting rod ball end seated within the socket cavity, with the retention means radially fully supported by side walls of the cylindrical bore such as to limit deformation of the retention means in operation of the pump/motor.

### BRIEF DESCRIPTION OF THE DRAWINGS

FIG. 1A shows a prior art swaged socket in which a gap is left between the swaged material and the socket bore, leaving the swaged material unsupported against pullout.

FIG. 1B is a sectional view of a connecting rod ball and socket having been fitted by a preferred swaging means that is the object of the invention.

FIG. 2 is a sectional view of a socket and ball prior to swaging, showing the initial fit of the ball and socket.

FIG. 3 is a sectional view of a socket and ball after swaging, showing the desired fit of the ball and socket.

FIG. 4 is a sectional view of a preferred swaging tool adapted for the purpose of the invention.

FIG. 5 is a sectional view showing the swaging tool at the beginning of swage.

FIG. 6 is a sectional view showing the swaging tool having swaged the socket lip around the ball.

FIG. 7 shows a radial swaging fixture under an alternative embodiment of the invention.

FIGS. 8A and 8B illustrate the radial swaging operation performed under the alternative embodiment of FIG. 7.

FIG. 9 is a sectional view showing a ball and socket assembly in which the ball is retained by a flat-surfaced retaining ring and a snap ring, under a second alternative embodiment of the invention.

FIG. 10 shows a detail of an example embodiment of the snap ring under the second alternative embodiment of the invention in FIG. 9.

FIG. 11 is a sectional view showing a ball and socket assembly in which the ball is retained by a concave retention ring, which itself is retained in the socket by means of a circular snap ring, under another embodiment of the invention.

FIG. 12 is a detail of FIG. 11, showing detail of the retention ring and a self-adjustment mechanism to accommodate wear.

FIG. 13 is an exploded view of a piston assembly and drive plate bore showing the relation of the various parts of the FIG. 9 and FIG. 11 embodiments of the invention.

### DETAILED DESCRIPTION OF THE INVENTION

All sectional views herein represent objects that are substantially radially symmetrical about a central axis, and therefore it will be appreciated that features identified on one side of a view correspond to those on the other side which may go unlabeled.

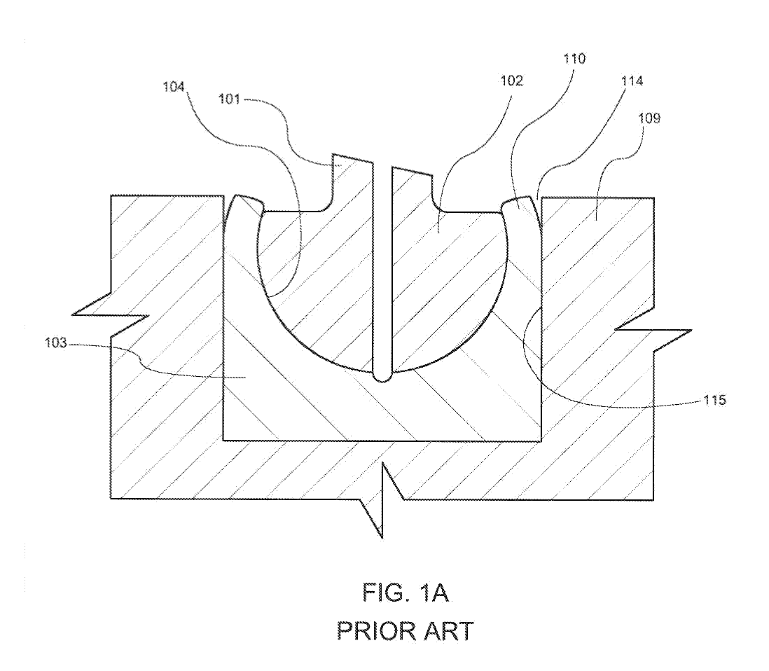

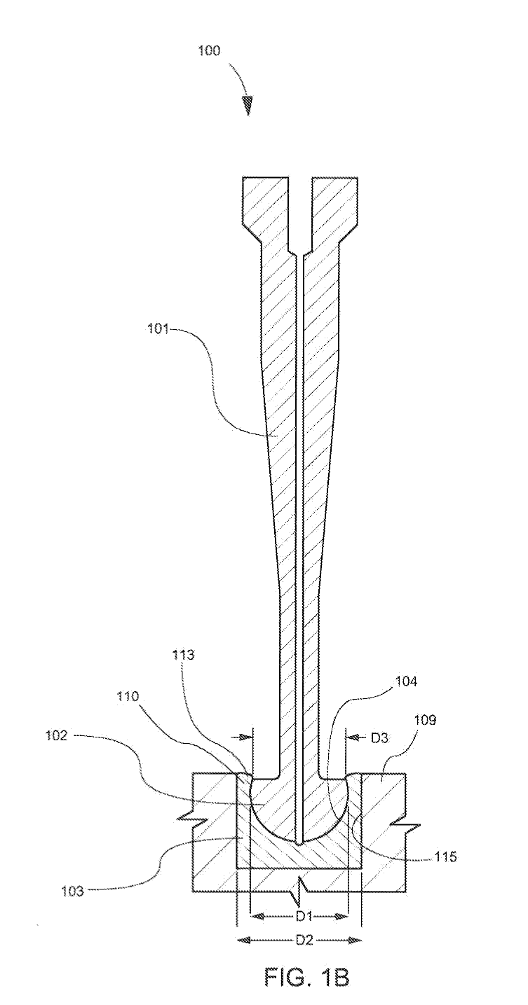

Referring to FIG. 1A, a prior art swaged socket is shown. Connecting rod 101 has generally spherical or semi-spherical ball end 102, and socket body 103 has generally semi-spherical socket cavity 104 receiving ball end 102. Socket body 103 is installed in cylindrical socket bore 115 of drive plate 109. Socket lip 110 has been swaged toward ball end 102, wrapping around a portion of ball end 102 for the purpose of retaining ball end 102 in socket cavity 104. The swaging of the material of socket lip 110 toward ball end 102 has displaced material inwardly, resulting in an annular gap 114 between socket lip 110 and the cylindrical side wall of bore 115 when the assembly is installed in the bore. It can be seen that, if the connecting rod 101 is pulled with sufficient force away from socket cavity 104, deformed socket lip 110 is therefore free to deform into gap 114, allowing the ball to escape the socket cavity 104 and causing the joint to fail. The presence of gap 114 can be described as leaving the swaged material 110 “unsupported” against pullout. If gap 114 were instead filled with a strong material, any outward deformation of swaged material 110 would be resisted by bore wall 115, resulting in a retention means that is defined herein as radially “fully supported” by the side walls of the cylindrical bore.

Referring now to FIG. 1B, a fully supported installation according to the invention is shown. Piston 100 includes a connecting rod 101 having generally spherical or semi-spherical ball end 102, and socket body 103 having generally semi-spherical socket cavity 104. Ball end 102 and socket cavity 104 both have a nominal diameter D1. Socket body 103 has nominal outer diameter D2 which is selected for installation into a similarly sized bore 115 on a drive plate 109. Connecting rod 101 freely articulates with respect to socket body 103 by means of ball end 102 residing within socket cavity 104. Ball end 102 is prevented from pulling out from socket body 103 by means of retaining material 113, which is a part of socket lip 110 that has been swaged to a diameter D3 that is smaller than diameter D1, thus creating ball wrap that retains the ball. The socket body 103 is installed in bore 115 of drive plate 109. Because the swaged lip 110 has been swaged to an outer diameter D2 which is substantially the same as that of the socket bore 115, there is no gap analogous to gap 114 of FIG. 1A, and the installation is said to be fully supported.

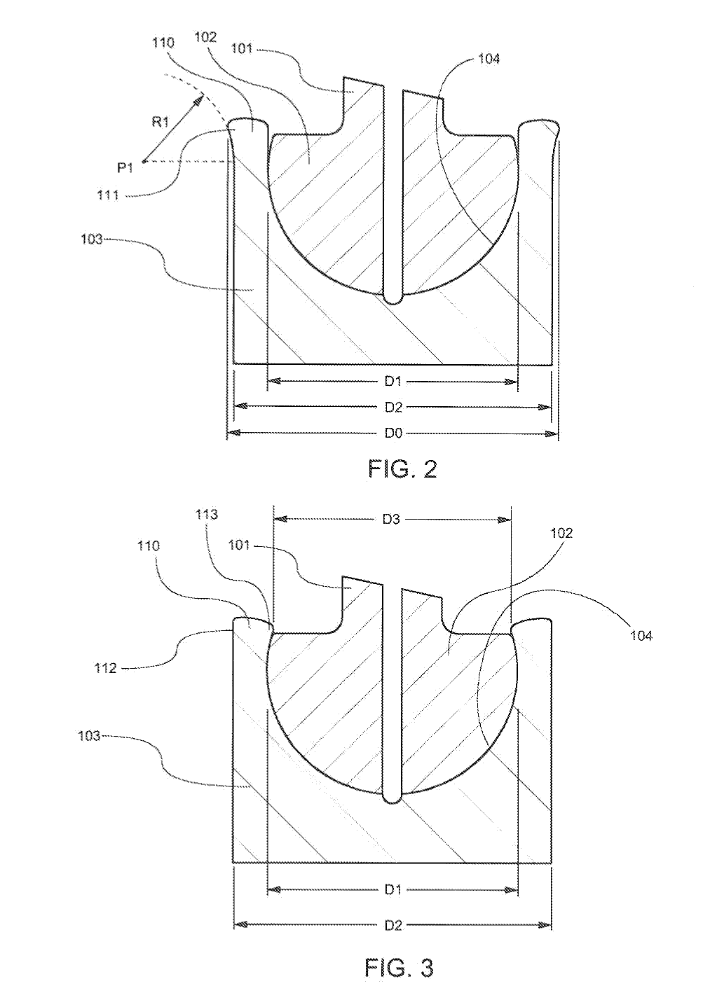

FIG. 2 details the initial form and fit of socket body 103 and ball end 102 prior to swaging. Socket lip 110 has internal diameter D1 (or larger), allowing ball end 102 to freely enter socket cavity 104. Socket body 103 has primary outer diameter D2, but socket lip 110 has additional material 111 forming a flare, making the outer diameter D0 of the lip larger than D2. The volume and shaping of additional material 111 is selected so as to provide the proper amount of material to deform over ball end 102 in order to hold it properly after swaging. Preferably, the amount of material 111 may be selected for a specific set of holding properties by specifying a radius R1 about a point P1 (point P1 representing all points on a circle about the vertical axis of socket blank 103, and radius R1 being a radius about each point in the direction of said vertical axis; for example, this preferred arrangement facilitates fabrication of socket blank 103 on a lathe).

FIG. 3 details the final form and fit of socket body 103 and ball end 102 after swaging. Socket lip 110 has deformed into the depicted position, now having internal diameter D3 which is smaller than the diameter D1 of ball end 102, thereby holding the ball within the socket body. Additional material 111 (FIG. 2) has migrated inwardly to within socket body outer diameter D2. Outer surface 112 of socket lip 110 now has diameter D2 to match that of the socket body, allowing for secure installation into a socket bore to the full depth of the socket body.

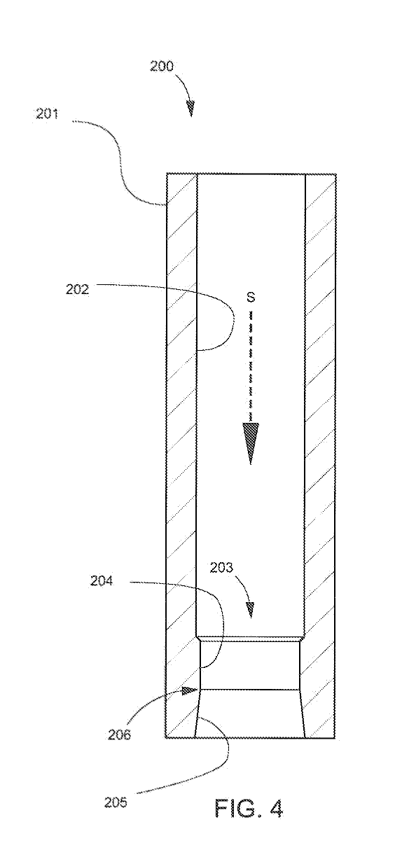

FIG. 4 depicts a preferred swaging tool for the foregoing operation. Swaging tool 200 includes sleeve 201 and bore 202 to accommodate a workpiece. Swage cavity 203 includes slanted portion 205 and straight portion 204. Straight portion 204 is substantially parallel to bore 202 or, more specifically, to stroke axis S through which the tool is applied to the workpiece. The junction between straight portion 204 and slanted portion 205 defines boundary 206. As depicted, the lower end of tool 200 is the engaging end, which would engage with a workpiece to be swaged. Slanted portion 205 is nearest the engaging end, such that the workpiece first engages with slanted portion 205, then with straight portion 204.

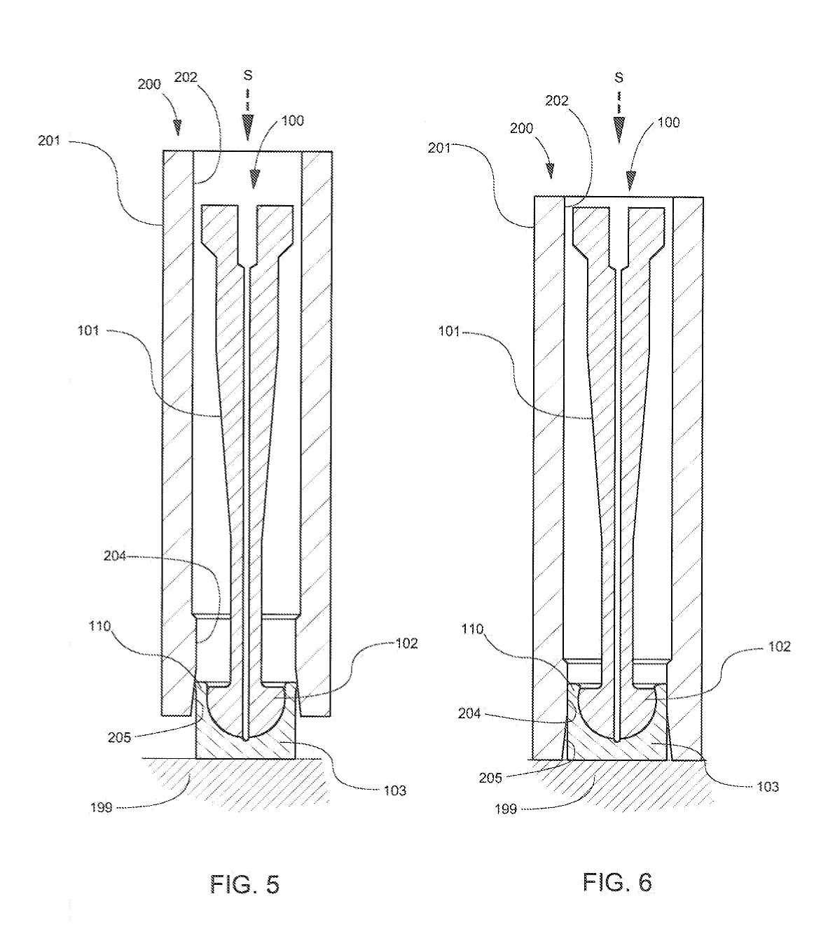

FIGS. 5 and 6 depict the beginning and end of the preferred swaging stroke, respectively. In FIG. 5, socket blank 103 is undeformed as previously depicted in FIG. 2, and rests upon a firm surface 199. Tool 200 has approached piston assembly 100 from above along stroke axis S, with connecting rod 101 being accommodated within bore 202. Slanted portion 205 of the swage cavity has just come into contact with socket lip 110 of socket blank 103. It may be seen that further movement of tool 200 along stroke axis S will cause the socket lip 110 to be deformed toward the ball 102 by the continuing slant of slanted portion 205. Still further movement would bring the deformed socket lip into contact with straight portion 204, burnishing the outer surface of the socket lip.

FIG. 6 depicts the end of the swaging process. Socket lip 110 has deformed to an inner diameter smaller than the outer diameter of ball end 102, thus retaining it within socket 103, and has an outer diameter equal to the diameter of straight portion 204.

Optionally, by providing an appropriate relief in surface 199, tool 200 could be further stroked, until straight portion 204 has swept most or all of the length of socket body 103, burnishing most or all of the outer surface of the socket body to the desired outer diameter.

In practicing the invention here disclosed, several variables may be considered in order to achieve the best result for a given material, part geometry, performance goal, or application. Referring again to FIG. 4, any of the following may be selected: the angle and/or length of slanted portion 205; the length of straight portion 204; the location of boundary 206; and the distance or speed along stroke axis S through which the tool 200 is applied to the workpiece. Further, referring again to FIG. 2, the initial geometry of the socket blank 103 may be selected, in particular, the amount of material in socket lip 110, which might, for example, be specified in terms of a radius R1 about a point P1.

In an alternate embodiment, the swaging operation initially swages material tightly around the ball such that the joint is not initially freely articulable. Then, an additional operation is performed to make the joint freely articulable with a desired amount of play, by exerting a pulling force on the connecting rod so as to pull it away from the swaged socket, plastically deforming the retaining edges of the socket sufficiently to create a desired amount of play between the ball and the upper portion of the socket cavity.

In another embodiment to be described in detail hereafter, radial swaging may be employed rather than the axial swaging of the previous embodiments. Radial swaging, in which swaging force is applied inwardly from the circumferential periphery of the socket cavity rather than from above the socket cavity, prevents certain axial stresses that would tend to distort the sphericity of the socket cavity.

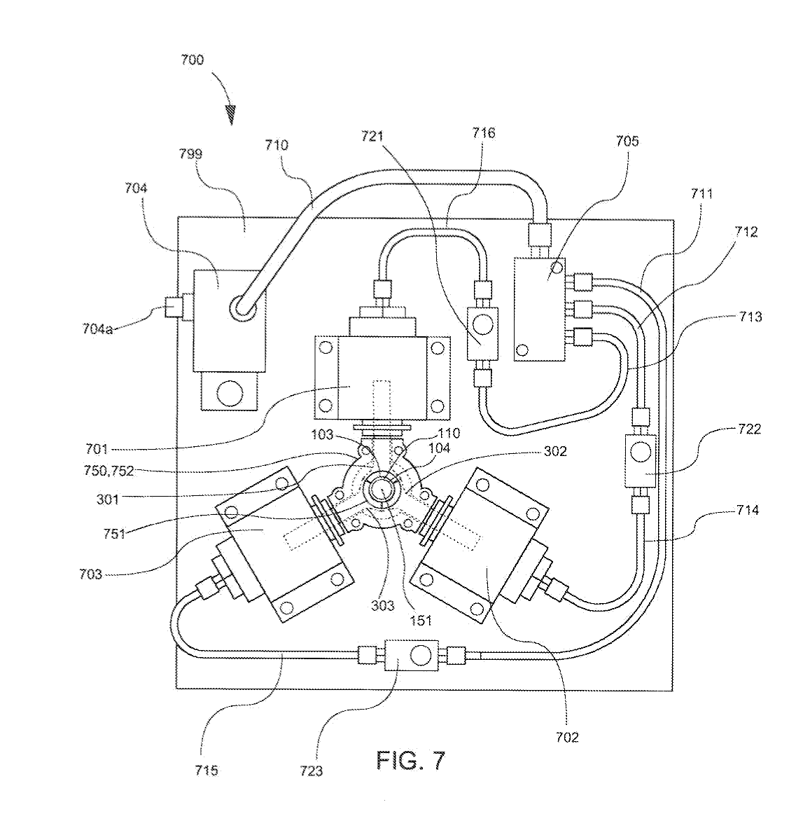

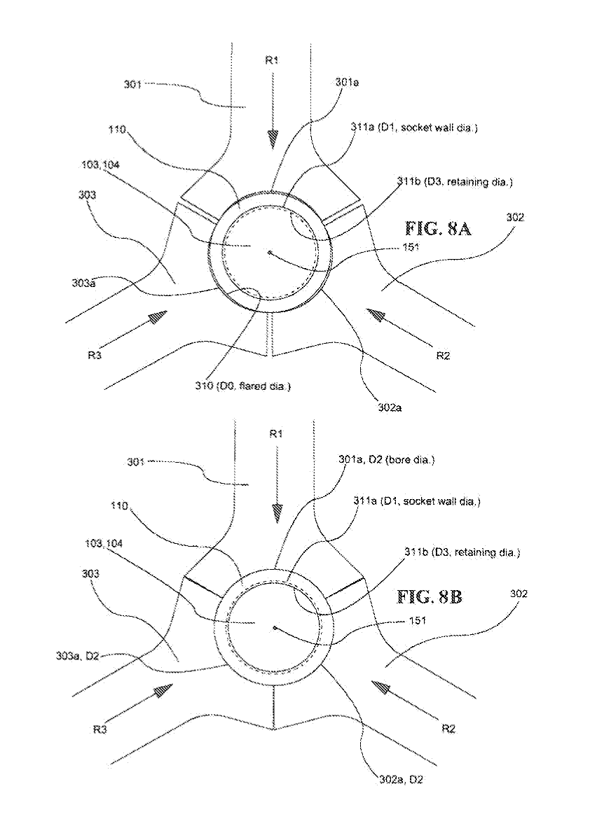

Referring to FIG. 7, a radial swaging fixture 700 includes base 799, hydraulic cylinders 701, 702, and 703 affixed to base 799, and a plurality of concentrically oriented swaging dies (preferably three) 301, 302, and 303 each having a respective circular arcuate swaging surface (shown in FIGS. 8A-8B as 301a, 302a, 303a). The dies 301-303 are configured to be pressed simultaneously by respective hydraulic cylinders 701, 702, 703 inwardly toward a central point 151 where a socket body 103 resides. Socket nest block 752 is also affixed to plate 799 and provides a stable resting place (such as example a circular hole) for socket body 103 to reside within. Top plate 750 is affixed to the top of nest block 752 (in FIG. 7, edges of 750 and 752 are coincident) and provides a stable platform covering the dies and the nest block, and provides hole 751 through which the socket body 103 may be inserted into the socket nest. Prior to swaging, a connecting rod ball, not shown, is positioned in socket cavity 104, preferably in a position such that the connecting rod (not shown) is substantially perpendicular to the open (top) side of the socket body that contains the socket cavity. Each die 301-303 is preferably spring mounted on its respective cylinder 701-703 so as to provide sufficient degrees of freedom of movement to automatically center the socket body 103 in the fixture as the dies press inwardly. Preferably each spring (not shown) is a wave spring, or any other spring which can allow the die two degrees of freedom.

Fluid is supplied to the hydraulic cylinders 301-303 by hydraulic line 710 routed through junction block 705 which distributes the fluid to hydraulic lines 711-713 to each respective cylinder 701-703. Manual or automatically controlled needle valves 721-723 reside on the three respective lines 711-713 (or alternatively, a single needle valve could be placed on line 710 upstream of junction block 705). A manual or automatically controlled 2 position, 3 way valve 704 or similar fluid control means may be used to apply and relieve hydraulic pressure to fixture 700 and thereby cause the radial swage to occur. Port 704a supplies fluid to valve 704.

Referring to FIGS. 8A-8B, in order to effect proper swaging, the curvature of surfaces 301a-303a preferably has a smaller radius than the curvature of the flared (pre-swaging) outer diameter 310 (or D0) of the socket lip 110. Preferably, the curvature of die surfaces 301a-303a has substantially the same radius as the curvature of the finished socket outer wall D2 (FIG. 8B). Therefore, contact between a die 301-303 and the socket body 103 occurs at the outer edge of the die first. As each die is inwardly pressed, the region of contact expands to the center of the die until the die is in full contact with the socket body and has thereby effected a radial swage. As an outcome of the above-described radial swage, the initial inner socket diameter 311a (or D1) is reduced to the final inner socket diameter 311b (or D3), thereby retaining the connecting rod ball in the socket as previously described.

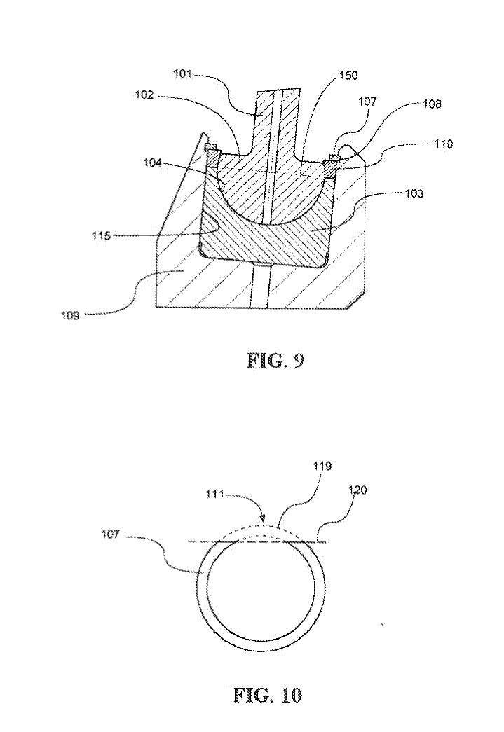

In yet another embodiment that will be fully described herein, depicted in FIGS. 9 to 13, insertable fully supported retention rings could also be used for the retention function.

Referring to FIG. 9, connecting rod 101 has generally spherical or semi-spherical ball end 102, and socket body 103 has generally semi-spherical socket cavity 104 receiving ball end 102. Socket body 103 is installed in cylindrical socket bore 115 of drive plate 109 (a portion of which is seen). Snap ring 107 resides above retaining ring 110 and extends into groove 108 in socket bore 115. It can be seen that, if connecting rod 101 is pulled away from socket cavity 104, retaining ring 110 and snap ring 107 prevent its exit from the socket cavity. Specifically, the function of retaining ring 110 is to provide an inwardly curved surface that opposes outward movement of the ball end, and snap ring 107 retains retaining ring 110 within bore 115.

It will be appreciated that, in order for retaining ring 110 to retain connecting rod ball end 102, the inner diameter of the ring must be smaller than the outer spherical diameter of the ball end, which means that it cannot be installed onto the connecting rod by slipping it over the ball end. If, in a given application, the diameter of the piston head is smaller than this inner diameter, it is possible to install retaining ring 110 around the ball end by slipping it past the piston head, and in this case, retaining ring 110 may be a continuous ring. On the other hand, in applications where the diameter of the piston head is also larger than this inner diameter, it is necessary that retaining ring 110 be split, or include a gap, to allow it to slip over a narrow portion of connecting rod 101 on installation. This may be achieved by including either a gap large enough to pass over the connecting rod, or by splitting retaining ring 110 into two or more pieces. Applications in which retaining ring 110 may be made as a continuous ring have the advantage of improved retention strength and durability, because the absence of a gap in the ring prevents circumferential flexing of the ring (which promotes the possibility of fatigue failure over time).

Further, whether the ring is continuous or gapped, retaining ring 110 is fully radially supported by the walls of bore 115, thereby resisting radial deformation when tension is placed on the ball and socket joint, and thereby improving the retention strength of the socket against pullout of ball end 102.

Referring now to FIG. 10, snap ring 107 has a generally circular shape but includes split region 111 which provides a passage through which to slip the ring past the connecting rod 101 (FIG. 9) on installation. Alternatively, since a snap ring is typically composed of spring material, split region 111 may be a simple break in the ring rather than a sizeable gap, allowing the snap ring to elastically deform sufficiently to pass the connecting rod. Snap ring 107 may be stamped in its gapped or split form, or initially manufactured as a stamped or similarly formed full ring 119, and then broken, or cut along a line such as line 120 (for example, by stamping, shearing, or a similarly applicable process) to form split region 111.

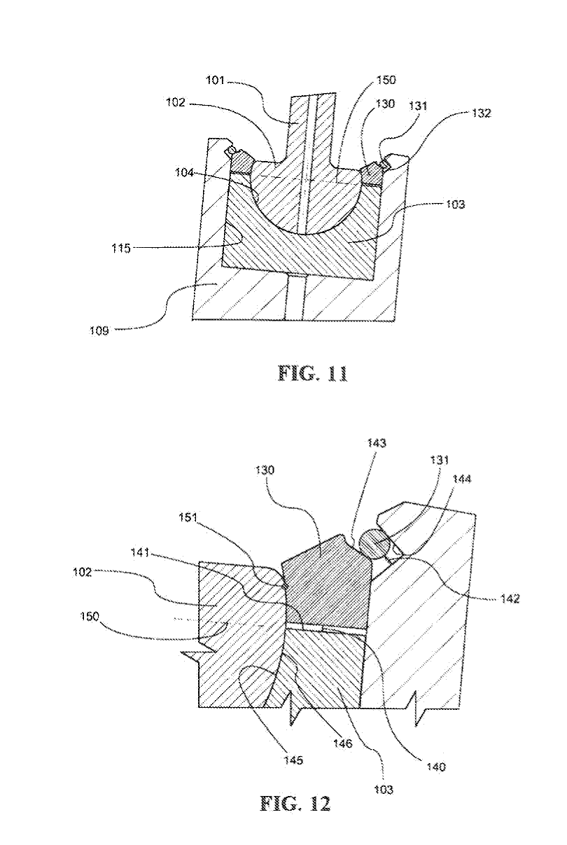

FIG. 11 shows another embodiment in which a retention ring is combined with a circular snap ring and groove, configured to cause the retention ring to be self-adjusting in order to snugly retain the ball end against the socket cavity even as the ball and socket surfaces wear. As in FIG. 9, socket body 103 is installed in socket bore 115 of drive plate 109. Ball end 102 resides in socket cavity 104. Retention ring 130 is placed above ball end 102 to provide an inwardly curving surface to oppose outward movement of ball end 102. Circular snap ring 131 is installed above retention ring 130 and expands into groove 132 which resides in the interior wall of cylindrical bore 115. It can be seen that, if the connecting rod 101 is pulled away from socket cavity 104, it is stopped by retention ring 130, which has been stopped by snap ring 131. Preferably, circular snap ring 131 is substantially circular in cross section, and groove 132 is substantially triangular in cross section. Snap ring 131 and groove 132 are placed significantly above ball centerline 150 in order to maximize support by the wall of bore 115.

Referring to FIG. 12, it can be seen that retention ring 130 contacts ball end 102 at a representative contact location 151 (a representative point on what would generally be expected to be a region of contact), causing a snug fit and preventing significant play between the ball and socket. However, as the sliding interface between the ball end surface 146 and socket cavity surface 145 wears, ball end 102 will gradually seat further into socket cavity 104. If retention ring 130 were to stay in its original position as this occurs, contact location 151 (and its associated region of contact) would become a gap, leading to a growing amount of play between the ball and socket. To prevent this, the angles of groove 132 and the upper surface of the retention ring 130 are optionally selected to cause retention ring 130 to self-adjust its snug fit to ball end 102 as the ball and socket surfaces wear, as next described.

Referring to FIG. 12, groove 132 defines a first surface 144 that is oriented at a first angle with respect to the cylindrical wall of bore 115 (FIG. 9). Retention ring 130 defines a second surface 143 that is oriented at a second angle. The first and second angles are selected so as to allow snap ring 131 to retain retention ring 130, while also causing snap ring 131 to exert its spring force in the direction of first gap 142, thereby urging retention ring 130 downward as the ball end 102 (and representative contact location 151) gradually recedes into the cavity. By this means, retention ring 130 can maintain snug contact at (representative) contact location 151. To provide space for this gradual migration of retention ring 130, self-adjustment gap 140 is provided between retention ring 130 and socket body top surface 141. Over time, accumulation of wear causes retention ring 130 to gradually enter gap 140, and snap ring 131 to gradually enter gap 142. A limit of self-adjustment is reached when the space in gap 140 is exhausted, after which further wear will begin to cause increasing play in the socket joint. As an example, a self-adjustment gap (140) of about 0.25 mm is appropriate for a snap ring cross sectional diameter of 1.25 mm.

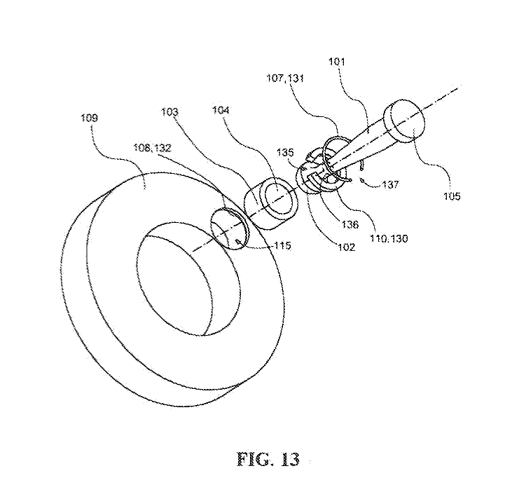

FIG. 13 details how the parts of the embodiments of FIGS. 9-11 relate to one another. A retention ring (110 of FIG. 9 or 130 of FIG. 11) and snap ring (107 of FIG. 9 or 131 of FIG. 11) are shown with respect to a connecting rod 101 and drive plate 109. Retention ring (110, 130) optionally includes gap space 135 which is wide enough to allow the ring to be installed around a relatively narrow diameter 136 of connecting rod 101. Gap space 135 may be omitted if the diameter of piston head 105 is small enough to pass through the inner diameter of retention ring (110, 130). Snap ring (107, 131) has gap space (or alternatively, a split) 137 sufficient to allow fitting about connecting rod 101 and installation into bore groove 132. Bore groove (108 of FIG. 9 or 132 of FIG. 11) is preferably machined into the wall of bore 115. The retention ring (110, 130) may be manufactured in a variety of known ways, including powder metal process, metal injection molding, cold forming, or deep drawing. Preferably, gap spaces 135 and 137, if present, are both oriented toward the center of drive plate 109.

Having discussed the goal of creating a ball and socket joint retention means that is fully supported by the cylinder walls of the bore into which it is installed, and multiple embodiments to accomplish the goal, it will now be apparent to those skilled in the art that other methods of attaining a fully supported socket fall within the scope and spirit of the invention, including for example, the use of a pressed or adhesively bonded ring or other insert to fill the annular space between the swaged socket lip and the cylinder bore walls. Additionally, the pressed-in ring could be used to perform the swaging operation itself, if desired. As yet another alternative, a liquid material (for example, molten metal, metal solder, or epoxy resin) could be allowed to flow into the space in order to rigidly fill it after the material hardens. Any such filler material may be used providing that it retains sufficient adhesiveness and compressive strength after solidifying in place that it fully supports the swaged portion of the socket and does not deteriorate or detach in operation.

The invention herein is therefore intended to be limited solely by the claims.

1. A ball and socket joint for a hydraulic pump/motor, comprising:
a cylindrical socket body, having a substantially semi-spherical socket cavity residing in a first end;
a substantially spherical or semi-spherical connecting rod ball end seated within the socket cavity, and having a spherical diameter substantially equal to the spherical diameter of the socket cavity, wherein the end of the socket body opposite the socket cavity resides at the bottom of a cylindrical bore of a drive plate of the hydraulic pump/motor; and
a retention means for keeping the connecting rod ball end seated within the socket cavity, wherein the retention means is radially fully supported by side walls of the cylindrical bore such as to limit deformation of the retention means by pull-out forces that occur in operation of the pump/motor.

2. The ball and socket joint of claim 1, wherein the retention means comprises a socket lip that has been swaged inwardly to wrap around the top of the ball end to retain the ball end within the socket cavity.

3. The ball and socket joint of claim 1, wherein the retention means comprises a retention ring resting on the socket body and encircling the connecting rod ball end.

4. The ball and socket joint of claim 3, further comprising a snap ring disposed above the retention ring to retain the retention ring.

5. A method for assembling a ball socket, comprising:
placing a connecting rod ball end into a socket interior cavity residing in an end of a cylindrical socket body, the socket body having a socket lip with a first, initial outer cylindrical diameter at the ball entrance into the socket cavity larger than a second outer cylindrical diameter of the socket body below the socket lip;
swaging the socket lip region of the socket body radially toward the ball such that the final outer cylindrical diameter of the socket lip equals the second outer cylindrical diameter.

6. The method of claim 5, wherein:
said swaging is an axial swaging that includes a burnishing stage performed by successive stages of a swage cavity of a swaging tool;
wherein said swage cavity includes a first, slanted region and a second, straight region;
wherein said slanted region defines a substantially frustoconical interior surface having a central axis substantially parallel to the central axis of the swage cavity and having the larger frustoconical diameter oriented toward the engaging end of the tool;
wherein said straight region defines a substantially cylindrical interior surface that is substantially parallel to the central axis of the swage cavity and has a cylindrical diameter substantially equal to said second, outer cylindrical diameter; and
said swaging is performed by the first, slanted region, and
said burnishing is performed by the second, straight region.

7. The method of claim 5, wherein said swaging is a radial swaging performed by a plurality of swaging dies each having a substantially circular arcuate swaging surface and each being pressed in a direction toward the axial center of the socket cavity.

8. The method of claim 5, wherein the swaged socket lip is fully supported radially by side walls of a cylindrical bore containing the socket body.

9. The method of claim 5, further comprising:
after the swaging step, pulling the ball and connecting rod away from the socket cavity to deform the swaged material slightly so as to create a desired degree of play between the ball end and the socket body.

10. A swaging tool used for assembling a ball socket, comprising:
a cylindrical bore;
a swaging cavity radially symmetrical with the bore, including a first, slanted region and a second, straight region, wherein the slanted region has a frustoconical interior surface having a central axis substantially parallel to the central axis of the swage cavity and having the larger frustoconical diameter oriented toward the engaging end of the tool, and wherein said straight region has a substantially cylindrical interior surface that is substantially parallel to the central axis of the swage cavity, and
wherein said swage cavity is configured such that the slanted region is nearest the engaging end of the tool.
